(19) United States
(12) Patent Application Publication
(10) Pub. No.: US 2014/0208963 A1
(43) Pub. Date: Jul. 31, 2014

(54) SLICER

(71) Applicant: Progressive International Corporation, Kent, WA (US)

(72) Inventor: Jennifer K. Cotter, Seattle, WA (US)

(73) Assignee: Progressive International Corporation, Kent, WA (US)

(21) Appl. No.: 14/166,684

(22) Filed: Jan. 28, 2014

Related U.S. Application Data
(60) Provisional application No. 61/758,597, filed on Jan. 30, 2013.

(51) Int. Cl. A23N 15/02

(52) U.S. Cl. CPC A23N 15/02
USPC 99/637

(57) ABSTRACT

A strawberry huller includes a blade that is attached to a housing, with a plunger configured to rotate the blade with respect to the housing. After the blade is inserted into the strawberry the plunger is pressed, causing the blade to rotate about the stem. The rotation of the blade produces a circular cut around the stem for ideal separation of the hull.

### PRIORITY CLAIM

This application claims the benefit of provisional application Ser. No. 61/758,597 filed Jan. 30, 2013, the contents of which are incorporated by reference.

### FIELD OF THE INVENTION

This invention relates to devices used for cutting stems from fruits, particularly including devices for removing the hull from a strawberry.

### BACKGROUND OF THE INVENTION

Strawberries are typically picked and separated from a plant in a fashion that leaves a leafy stem attached to the fruit. Removing the leafy stem from the strawberry can be a tedious task. Many people commonly use a paring knife to remove the stem, and because strawberries are relatively small, the use of a knife requires some careful work to avoid cuts. In addition, even small paring knives are often larger than the ideal size for the task, resulting in cuts that are uneven and that remove more of the strawberry than is desired. Other than knives, there are some devices specifically made for hulling strawberries, but in general such devices nip or tug at the stem. In some cases the stem may separate cleanly, but in other cases it may rip apart, leaving part of the stem still attached in a jagged fashion.

### SUMMARY OF THE INVENTION

The present invention relates to a strawberry huller having a blade that is attached to a housing and a plunger configured to rotate the blade with respect to the housing. After the blade is inserted into the strawberry the plunger is pressed, causing the blade to rotate about the stem. The rotation of the blade produces a circular cut around the stem for ideal separation of the hull.

In accordance with preferred versions of the invention, the blade is angled inward to produce a conical-shaped cut as the blade is rotated. The blade is also attached in a fixed fashion to a rotating plunger so that the blade produces a conical cut defined by the shape and angle of the blade.

In a preferred version the blade is formed in a triangular or tear-drop shaped and rounded to further facilitate the creation of a conical cut.

### BRIEF DESCRIPTION OF THE DRAWINGS

Preferred and alternative examples of the present invention are described in detail below with reference to the following drawings:

FIG. 1 is a perspective view of a preferred version of a strawberry huller.

FIG. 2 is a side view of a preferred version of a strawberry huller.

FIG. 3 is a front view of a preferred version of a strawberry huller.

FIG. 4 is an exploded view of a preferred version of a strawberry huller.

FIG. 5 is a top view of a preferred version of a strawberry huller.

FIG. 6 is a sectional view of the strawberry huller of FIG. 5, taken along line 6-6 of FIG. 5.

FIG. 7 is an exploded view of a preferred version of a strawberry huller.

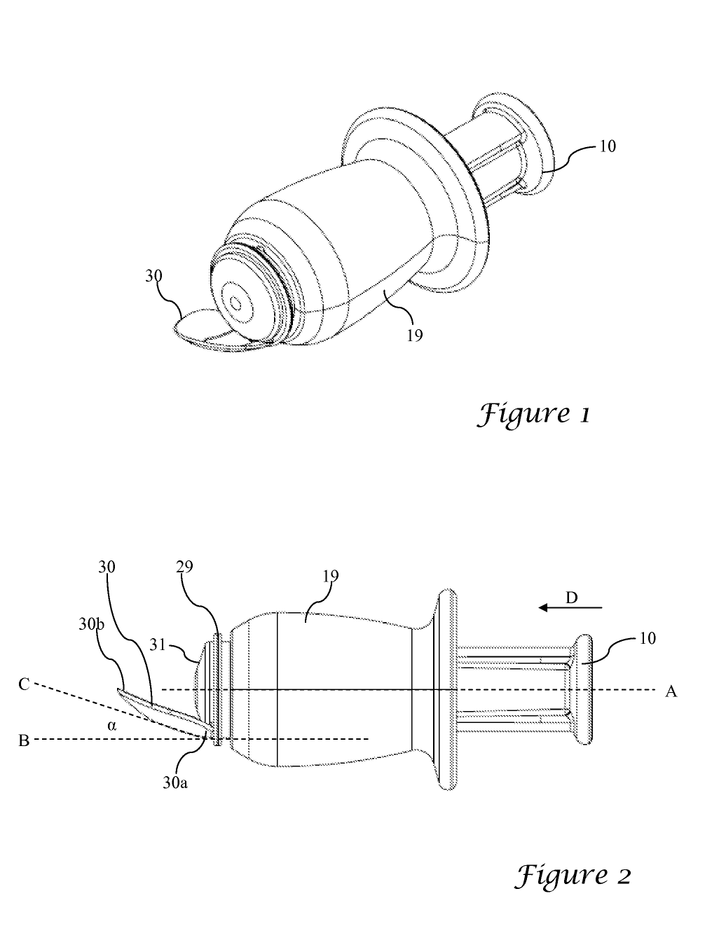

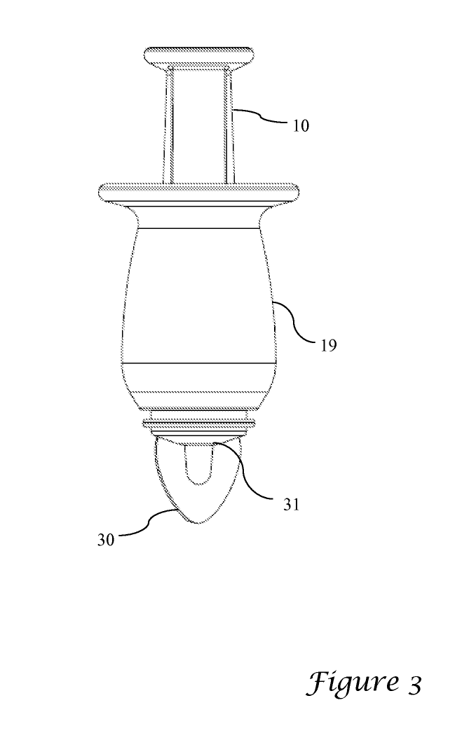

### DETAILED DESCRIPTION OF THE PREFERRED EMBODIMENT

With reference to the accompanying figures, a preferred strawberry huller includes a plunger 10 configured to be received within a housing 19 formed by two housing halves 20, 21. In other versions, the housing may be formed as a single component rather two halves joined together, or may be formed from more than two sections. The plunger is positioned within the housing for axial movement back and forth along a central axis A as illustrated in FIG. 2, such that the plunger can be pressed into the housing (in the direction of arrow D) and return back to an original position in which the plunger is at least partially extending out of the housing.

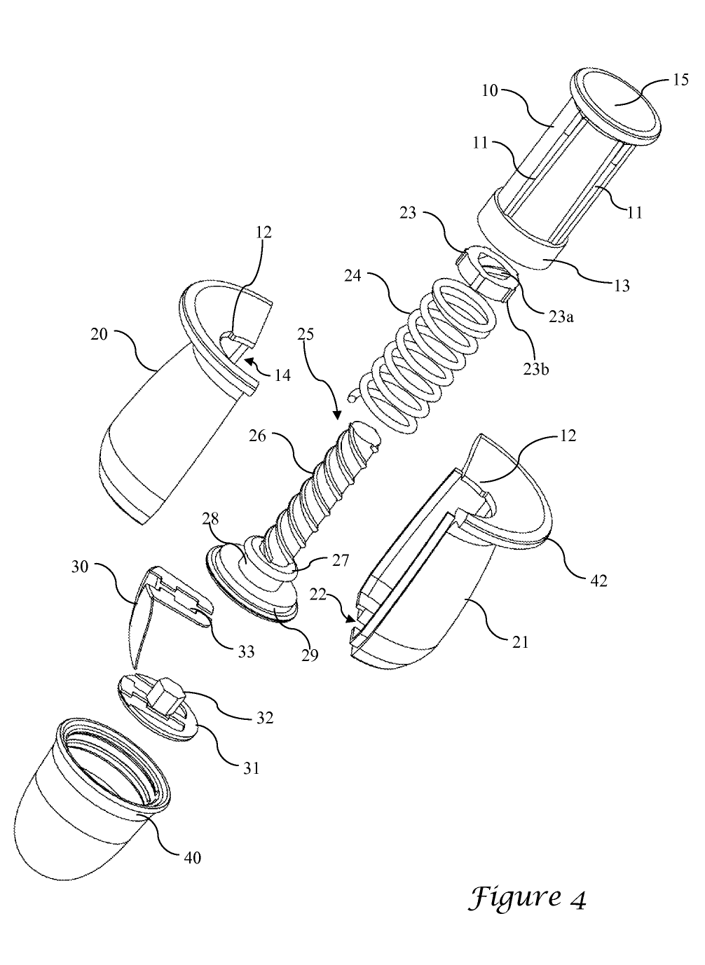

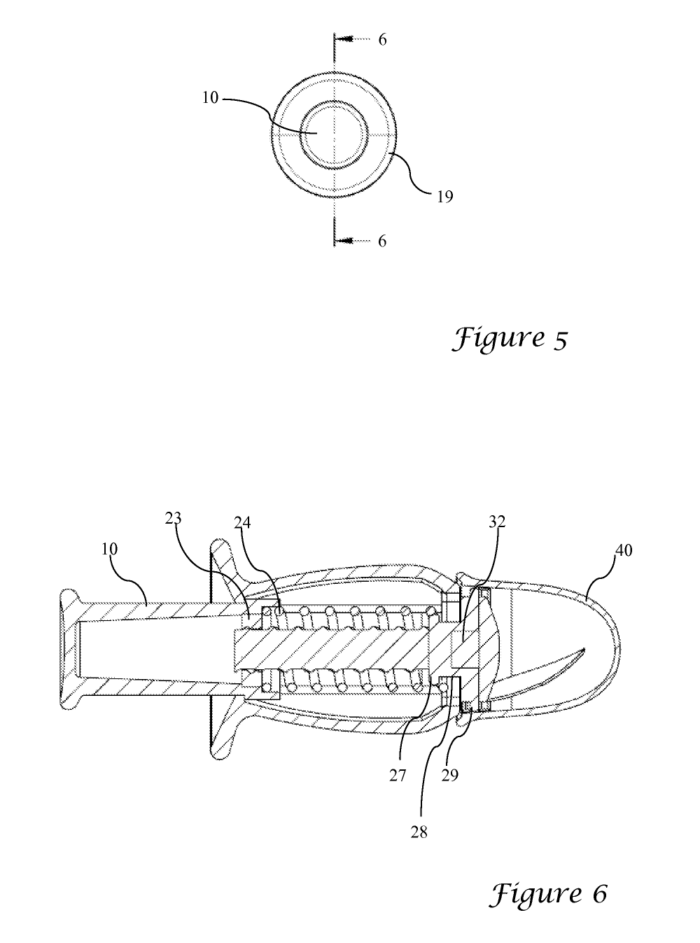

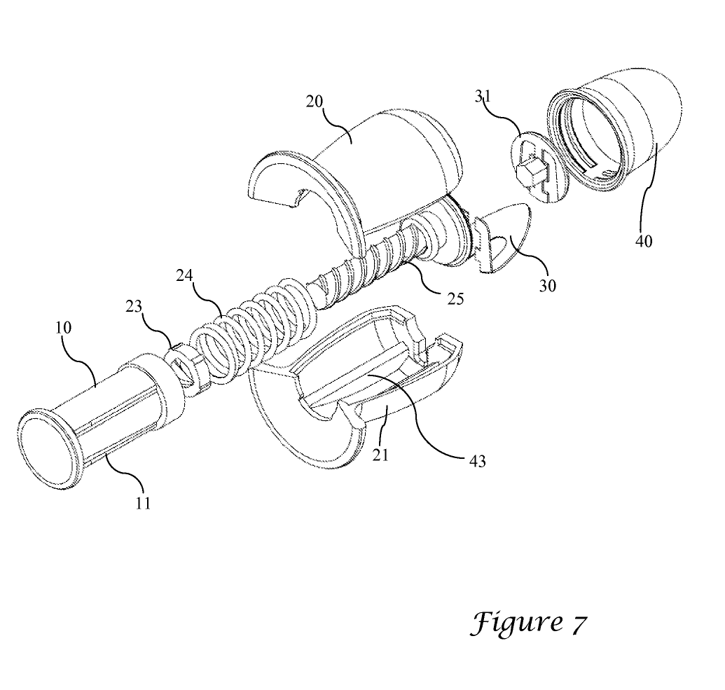

In a preferred version as best seen in the exploded view of FIG. 4, the plunger 10 is substantially cylindrical in shape, though it may include one or more ribs, grooves, channels, or other features 11 formed on an outer surface of the plunger and which interact with a complementary surface feature 12 formed in an opening, or neck 14, on the housing. Additional ribs or similar features 43 (see FIG. 7) may be formed on an interior wall of the housing or otherwise supported within the housing to further restrain the plunger against rotational movement. In the illustrated version, both the plunger and the housing include elongated ribs extending substantially along the entire length of the plunger and the housing. In this fashion, the surface features on the plunger interact with the shape of the opening of the housing and the rib within the housing such that the plunger is restrained against rotational movement as it moves axially into or out of the housing.

The plunger 10 is formed with a hollow interior, terminating at a proximal end with a cap or knob 15 that preferably encloses the internal plunger cavity. The cap at the proximal end is operable by a thumb of a user to push the plunger into the housing, as described further below. At the distal end of the plunger, the plunger terminates in a widened flange or rim on a distal endcap 13, in which the rim has an outside diameter somewhat larger than the outer diameter of the housing neck 14. The rim thereby provides a shoulder or surface that abuts the top inner surface formed in a neck 14 of the hollow housing so that the plunger is retained within the housing.

A spindle 25 is received within the hollow cavity of the plunger 10. The spindle is preferably in the form of a cylinder having threads 26 formed about an outer surface of the spindle. The spindle includes a base 29 and a spindle bearing 28 between the base and a locking flange 27. The spindle bearing is sized and configured to be received by an opening 22 formed at a distal end of the housing, with the spindle bearing and opening each being generally circular in cross section so that the spindle is rotatable within the opening. The spindle base 29 and flange 27 are each sized to be larger than the opening so that the spindle bearing is trapped within the opening 22 for rotational movement when the spindle is in position within the housing. In the preferred version, the spindle base, flange, and bearing are all integrally formed with the spindle.

A nut 23 having internal threads 23a, or at least one internal projection for interaction with the spindle, is positioned within the distal end of the plunger, preferably fixed in a space within the endcap 13 of the plunger 10. One or more external ribs 23b is preferably formed on the nut 23 to mate with a corresponding surface within the endcap 13 to retain the nut within the endcap and restrict it against rotational movement within the endcap. The internal threads or projections of the nut 23 are sized and configured to smoothly ride between threads 26 of the spindle such that axial travel of the nut with respect to the spindle will rotate the spindle while the nut remains in a fixed rotational position.

A spring 24, preferably a coil spring as illustrated, is positioned within the housing such that a first end of the spring will abut the interior of the base 29 of the spindle while the opposite second end of the spring will abut a shoulder formed at the distal end of the plunger. The shoulder may be formed, for example, within the rim or an inward-extending flange on the endcap 13, or may be a surface of the nut 23.

When the spindle, spring, and distal end of the pusher are retained within the housing (and the two housing halves 20, 21 are glued or otherwise secured to one another), the spring 24 urges the pusher axially away from the base of the spindle, in the opposite direction of the arrow D in FIG. 2. When a user pushes on the knob 15 formed on the proximal end of the spindle, it causes the plunger 10 (and the nut 23) to move axially downward toward the base of the spindle. Because of the threaded interaction of the nut and the spindle, coupled with the retention of the base of the spindle within the opening 22 in the housing, and the features 12 on the neck 14 and plunger 11 that prevent rotational movement of the plunger, the downward axial movement of the plunger will cause the spindle to rotate within the housing.

A top portion of the housing flares outwardly into a wide flange 42, which in the preferred example extends about the entire perimeter of the proximal end of the housing. The flange is sized and configured to be grasped by two fingers of a user to hold the housing while a user's thumb presses downward on the knob or cap 15 plunger.

A blade 30 is secured to the base 29 of the spindle 25. In the illustrated version, the blade is integrally formed with a base 33 forming a clip, with the blade forming an angle with respect to the base. Most preferably, the blade and clip are formed from metal such as stainless steel. The blade is attached to the base 29 of the spindle via a cap 31 and a fastener 32. In one example, the base 33 of the blade is positioned within complementary channels formed in the cap 31 and held against the cap by the fastener 32. The fastener is then securely received within a cavity formed in the base 29 in a manner that ensures the blade 30 will rotate together with the rotation of the base 29 and the spindle 25.

In a preferred version of the invention, a cover 40 is provided. The cover is sized and configured to receive the blade within it, and includes a rim configured for a snap-fit attachment to the base so that the rim is removably attachable to the base. The cover may alternatively include a friction, threaded, or other means of attaching the cover to the housing or the base of the spindle.

In one example, the blade is angularly oriented with respect to the central axis, as best seen in FIG. 2. Thus, a central axis A extends through the center of the plunger 10, spindle (not visible in FIG. 2), and housing 19. The blade 30 and base 29 of the spindle (which is positioned to lie in a plane parallel to the blade clip) form an angle with respect to one another, with a base of the blade and the spindle being substantially tangential to an axis B that is parallel to central axis A and offset from axis A toward the perimeter of the housing. The base of the blade 30a is positioned at the peripheral end of the cap 31 so that the base of the blade rotates circumferentially about the perimeter defined by the cap 31. Thus, in a preferred version of the invention the blade 30 has a base 30a which is positioned relatively toward the perimeter of the base 29 of the spindle and the perimeter of the cap 31, with the tip of the blade 30b being angled inward and terminating at a position on or close to the central axis A.

The angular orientation of the blade is such that the blade primarily extends along a third axis C, with the third axis C forming an angle α with respect to the offset second axis B. In a preferred example of the invention, the blade is angled with respect to the second axis B at an angle of about 30 degrees. In other preferred example the blade forms an angle of between about 20 degrees and 45 degrees with respect to the central axis (and therefore the offset axis).

The blade further defines a length that extends from a base 30a of the blade (generally at or near a perimeter of the base) to the tip 30b of the blade. The tip of the blade is positioned such that, in a preferred version, the tip is tangential to the longitudinal axis A. The base of the blade is further positioned along the perimeter of the base, which forms a circle. The base of the blade preferably curves along an arc defined by the length of the blade occupied by the portion of the base adjacent the base of the blade. Thus, the blade is somewhat concave, being curved along its width in a fashion that approximates the curvature of the perimeter of the base. In one version, the tip of the blade is also curved in a direction toward the longitudinal axis A, so that the blade is generally spoon shaped. Consequently, rotation of the blade in a full circle about the base will define a cone having the central axis A at its center.

In use, the blade is pressed into a strawberry at an angle so that the tip of the blade will be at the center of the strawberry stem and the base of the blade at an outer periphery of the stem. The plunger is then depressed, causing the blade to rotate one or more times and thereby carving out a conical portion about the stem of the strawberry. When the plunger is released, the blade will rotate in the opposite direction. The blade is then removed from the strawberry, and the spoon-shape of the blade aids as a scoop to pull the stem from the surrounding strawberry hull.

While the preferred embodiment of the invention has been illustrated and described as noted above, many changes can be made without departing from the spirit and scope of the invention. For example, the configuration of the spindle and nut may be reversed such that the plunger includes internal threads along substantially its entire length and the spindle includes one or more bearings that ride within the threads formed in the plunger housing. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A strawberry huller, comprising:
a housing having a proximal end and a distal end, with a central axis extending from the proximal end to the distal end;
a plunger supported by the housing for axial movement into and out of the proximal end of the housing; and
a blade pivotally secured to the huller at the distal end of the housing;
whereby axial movement of the plunger with respect to the housing causes corresponding rotational movement of the blade with respect to the housing.

2. The strawberry huller of claim 1, further comprising a spindle secured to the housing, the spindle having a spindle base, the blade being attached to the spindle base.

3. The strawberry huller of claim 2, wherein the plunger comprises an internal cavity and the spindle comprises external threads, and further wherein the spindle is positioned in the housing for axial movement into and out of the plunger.

4. The strawberry huller of claim 3, wherein the plunger further comprises a projection extending inward toward the internal cavity, the projection being sized and configured to mate with the treads of the spindle.

5. The strawberry huller of claim 4, further comprising a spring carried within the housing and connected to the plunger, the spring being positioned to urge the plunger in a direction axially toward the proximal end of the housing.

6. The strawberry huller of claim 5, wherein the spring comprises a coil spring positioned to surround the spindle.

7. The strawberry huller of claim 5, wherein the plunger comprises a first surface and the housing comprises a second surface, the first and second surfaces being complementary to one another and configured to restrict rotational movement of the plunger when it moves axially into and out of the housing.

8. The strawberry huller of claim 7, wherein the first surface comprises a rib extending longitudinally between the proximal end of the plunger and the distal end of the plunger.

9. The strawberry huller of claim 6, wherein the blade includes a base and a tip, the base of the blade being positioned substantially at the perimeter of the spindle base, the tip of the blade being angled inward with respect to the base of the blade.

10. The strawberry huller of claim 7, wherein the tip of the blade is positioned substantially on the central axis.

11. A strawberry huller, comprising:
a housing having a proximal end and a distal end, with a central axis extending from the proximal end to the distal end;
a plunger secured to the housing for axial movement into and out of the proximal end of the housing;
a spindle secured to the housing for rotational movement of the spindle with respect to the housing, the spindle being connected to the plunger; and
a blade linked to the spindle and extending away from the distal end of the housing;
whereby axial movement of the plunger with respect to the housing causes corresponding rotational movement of the spindle and the blade with respect to the housing.

12. The strawberry huller of claim 11, wherein the blade comprises a base and a tip, the base of the blade defining a perimeter of rotation of the blade, the tip of the blade being angled inward with respect to the base of the blade wherein the tip of the blade is positioned inside the perimeter of rotation.

13. The strawberry huller of claim 11, wherein the blade is formed with a concave shape.

14. The strawberry huller of claim 11, wherein the housing further comprises a neck at the proximal end of the housing, the plunger having a first surface and the neck having a second surface, the first and second surfaces being complementary to one another and configured to restrict rotational movement of the plunger when it moves axially into and out of the housing.

15. The strawberry huller of claim 11, further comprising a spring carried within the housing and connected to the plunger, the spring being positioned to urge the plunger in a direction axially toward the proximal end of the housing.

16. The strawberry huller of claim 11, further comprising a cover removably attached to the distal end of the housing, the cover enclosing the blade when the cover is attached to the housing.

17. The strawberry huller of claim 11, wherein the plunger comprises an internal cavity and the spindle comprises external threads, and further wherein the spindle is positioned in the housing for axial movement into and out of the plunger.

18. The strawberry huller of claim 11, wherein the proximal end of the housing further comprises a flange extending away from the proximal end of the housing.
